(19) United States
(12) Patent Application Publication
(10) Pub. No.: US 2006/0167665 A1
(43) Pub. Date: Jul. 27, 2006

(54) Automated system and method for service and cost architectural modeling of enterprise systems

(76) Inventor: Nabil A. Abu El Ata, (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/302,988

(22) Filed: Dec. 13, 2005

Related U.S. Application Data
(63) Continuation-in-part of application No. 09/942,096, filed on Aug. 28, 2001.
(63) Continuation-in-part of application No. 09/606,869, filed on Jun. 29, 2000, now Pat. No. 6,990,437.
Application No. 09/942,096 is a continuation-in-part of application No. 09/127,191, filed on Jul. 31, 1998, now Pat. No. 6,311,144.
(60) Provisional application No. 60/228,702, filed on Aug. 29, 2000.
(60) Provisional application No. 60/142,313, filed on Jul. 2, 1999.
(60) Provisional application No. 60/085,350, filed on May 13, 1998.

(51) Int. Cl. G06F 7/60

(52) U.S. Cl. 703/2

(57) ABSTRACT

An automated system and method is provided for system architects to model enterprise architectures of information systems. From an initial model of a proposed system architecture, performance metrics are modeled and compared against a set of user-defined corporate and business requirements. The performance metrics include cost, quality of service and throughput. For unacceptable metrics, modifications to the system architecture are determined and proposed to the system architect. If accepted, the model of the system architecture is automatically modified and modeled again. Once the modeled performance metrics satisfy the corporate and business requirements, a detailed description of the system architecture derived from the model may be output for further development stages.

### RELATED APPLICATIONS

This application is a continuation-in-part of U.S. application Ser. No. 09/942,096, filed Aug. 28, 2001, which claims the benefit of Provisional Application No. 60/228,702, filed Aug. 29, 2000, claims priority to application Ser. No. 09/606,869 filed Jun. 29, 2000 which claims the benefit of U.S. Provisional Application No. 60/142,313, filed Jul. 2, 1999, and further claims priority to U.S. application Ser. No. 09/127,191, filed Jul. 31, 1998 (now U.S. Pat. No. 6,311,144) which claims the benefit of U.S. Provisional Application No. 60/085,350, filed May 13, 1998. This application further claims priority to (a) application Ser. No. 10/005,481, filed Oct. 26, 2001, and (b) U.S. application Ser. No. 10/014,317, filed Oct. 26, 2001.

The entire teachings of the above applications are incorporated herein by reference.

### BACKGROUND OF THE INVENTION

With the advent of electronic computing, business organizations, such as financial institutions, have utilized information systems to provide a computerized infrastructure for supporting business processes. An information system includes a number of interconnected hardware and software components, implementing one or more business solutions. The architectures of such systems are typically required to handle varying degrees of workload and priorities under imposed business constraints.

The design of system architectures having such requirements and constraints represents a real challenge. Most existing methodologies, tools and techniques concentrate on static, partial descriptions of computerized business infrastructures. Dynamic system behavior is generally unknown until the information system is in construction or in operation, thus, limiting the possibilities for improvement. Unacceptable performance issues may become exacerbated as a system evolves with the addition of new business applications that must be supported by the architecture.

Furthermore, when the origin of a problem resides in questionable decisions made early in the development process, the cost of improvement could become prohibitive when a redesign of the system architecture is required at some level. Thus, a tremendous amount of investment may be lost due to the design of unacceptable system architectures.

### SUMMARY OF THE INVENTION

Embodiments of the invention provide an automated system and method for designing model based architectures of information systems. Embodiments of the automated system and method may be implemented in computer aided design tools utilized by system architects. Such embodiments provide a business process design, which describes a number of business processes and defines a set of business requirements for each business process. A multi-layer mathematical model of a system architecture is constructed from the business process design and has a business layer, an application layer, and a technology layer. Once the initial model is constructed, performance metrics are modeled at each layer. For each business process, the modeled performance metrics are compared with a set of business requirements, producing respective indications of unacceptable performance metrics of one or more business processes. For business processes having unacceptable performance metrics, modifications to the system architecture are determined and proposed to the system architect for acceptance. If accepted, the model of the system architecture is modified with the accepted modifications and the performance metrics are updated at each layer. If the updated performance metrics satisfy the business requirements, an output of a description of the resulting system architecture is available.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates the functional modules of an automated system for designing model based architectures according to one embodiment of the present invention.

FIGS. 2A and 2B illustrate a flow diagram of an automated design process for designing model based architectures using the embodiment of FIG. 1.

FIG. 3 is a diagram illustrating the graphical layout of a business process design according to one embodiment.

FIG. 4 illustrates a model based architecture of an information system resulting from the automated design process according to the embodiment of FIGS. 1, 2A and 2B.

### DETAILED DESCRIPTION OF THE INVENTION

A description of preferred embodiments of the invention follows.

Embodiments of the invention provide an automated system and method for system architects to design model based architectures of information systems. A model based architecture is a system architecture that is designed from modular hardware and software component models and validated through performance modeling. With validation through performance modeling, a model based architecture is more robust and secure than system architectures designed solely on the experience of a system architect. Embodiments of the automated system and method may be implemented in computer aided design tools utilized by system architects.

In brief overview of the present invention, a system architect is provided a series of graphical user interfaces through which to construct an initial model of a system architecture from a business process design. Upon providing the business process design, embodiments of the automated system provide a selectable list of premodeled business applications, which are coupled to a set of default hardware and software component models. The initial model is constructed by simply mapping the available business applications to corresponding business processes defined in the business process design. Thus, the system architect is relieved from defining the supporting hardware and software components. After the initial model is constructed, embodiments of the automated system iterate through sequences of performance modeling, comparison, and architecture modification stages until the modeled metrics satisfy the business requirements of the business process design. Once the business requirements are satisfied, a detailed set of specifications describing the system architecture are derived from the resulting model.

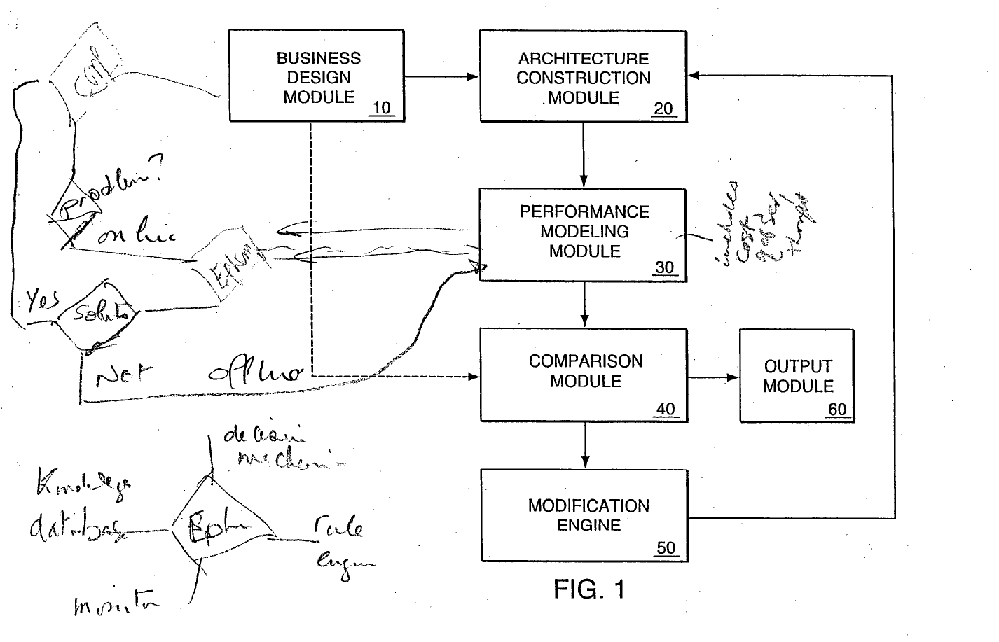

FIG. 1 illustrates the functional modules of an automated system for designing model based architectures according to one embodiment of the present invention. Embodiments of the automated system include a business design module 10, an architecture construction module 20, a performance modeling module 30, a comparison module 40, a modification engine 50, and an output module 60.

The business design module 10 provides a graphical layout interface, through which a system architect can provide a business process design. A business process design identifies business processes within a business organization and the flow of communication and workload among them. Furthermore, the business process design defines a set of business requirements for each individual business process.

The architecture construction module 20 provides a graphical user interface through which a system architect constructs a multi-layer mathematical model of a system architecture supporting the business process design input at business design module 10. The layers of the model include a business layer, an application layer, and a technology layer. The business layer includes the business process design, while the application and technology layers include software and hardware component models, respectively, that support the business process design. For more information regarding the structure of a multi-layer mathematical model, refer to U.S. patent application Ser. No. 09/127,191 entitled “Method and Apparatus for Designing and Analyzing Information Systems Using Multi-Layer Mathematical Models,” filed Jul. 31, 1998, the entire contents of which are incorporated herein by reference.

The performance modeling module 30 models performance metrics at each layer of the multi-layer mathematical model of the system architecture. Some of the business requirements, such as definitions of business flow and workload, are utilized in calculating the performance metrics.

For each business process, the comparison module 40 compares the modeled performance metrics output by performance modeling module 30 with the defined set of business requirements provided at business design module 10. The comparison module 40 produces indications of whether one or more business processes exhibit unacceptable performance metrics that do not satisfy the input business requirements.

If unacceptable modeled business performance metrics are identified, a rule-based modification engine 50 determines appropriate modifications to the model of the system architecture in order to improve the unacceptable business performance metrics and proposes the modifications to the system architect for acceptance.

If accepted, the architecture construction module 20 automatically incorporates the proposed modifications into the model of the system architecture without further assistance from the system architect. The performance metrics for the modified system architecture are updated by the performance modeling module 30 and compared again by the comparison module 40. If the modeled business performance metrics do satisfy the business requirements, an output module 60 provides a detailed description of the system architecture to the system architect for use in subsequent implementation stages. Otherwise, embodiments of the automated system continue to iterate through the modification, modeling, and comparison stages of modules 50, 20, 30, and 40. This process continues until either the modeled performance metrics of each business process satisfy the business requirements or the performance metrics of the supporting hardware and software component models cannot be improved further without a change to the business process design.

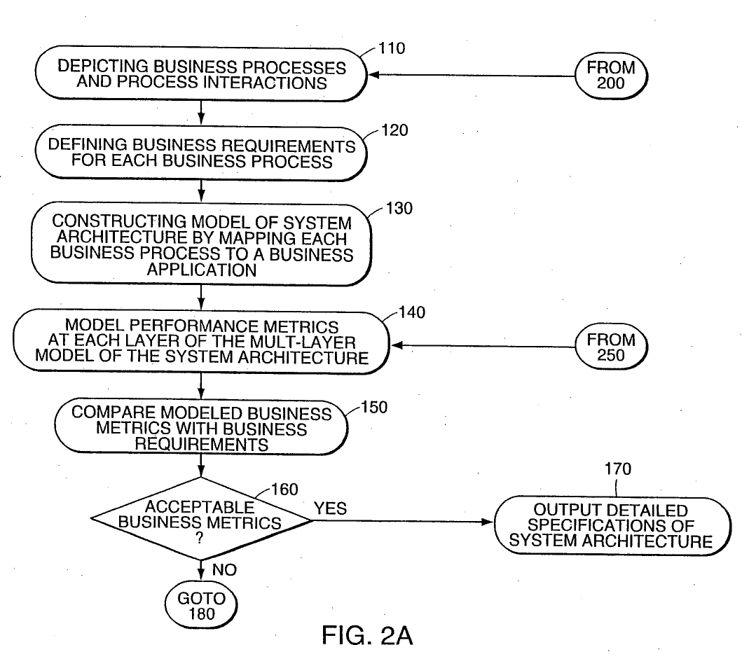

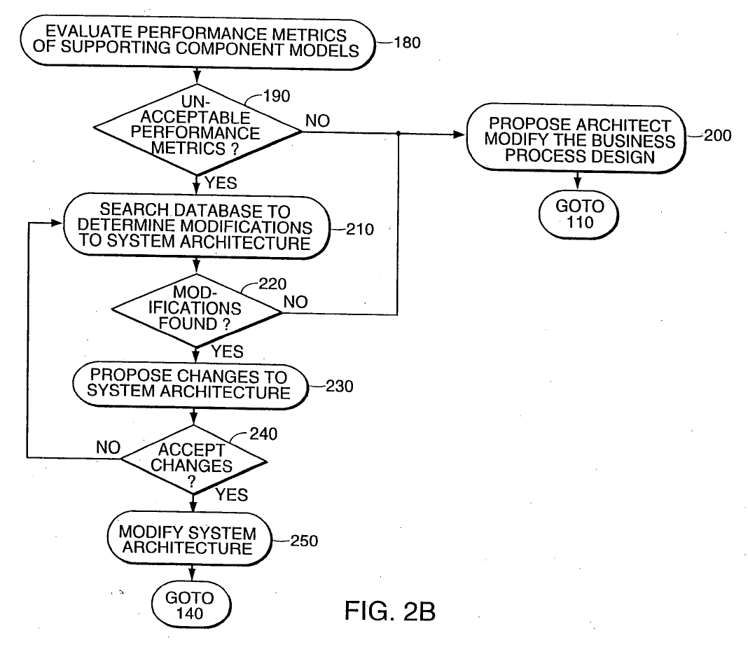

FIGS. 2A and 2B illustrate a flow diagram of an automated design process for designing model based architectures using the embodiment of FIG. 1.

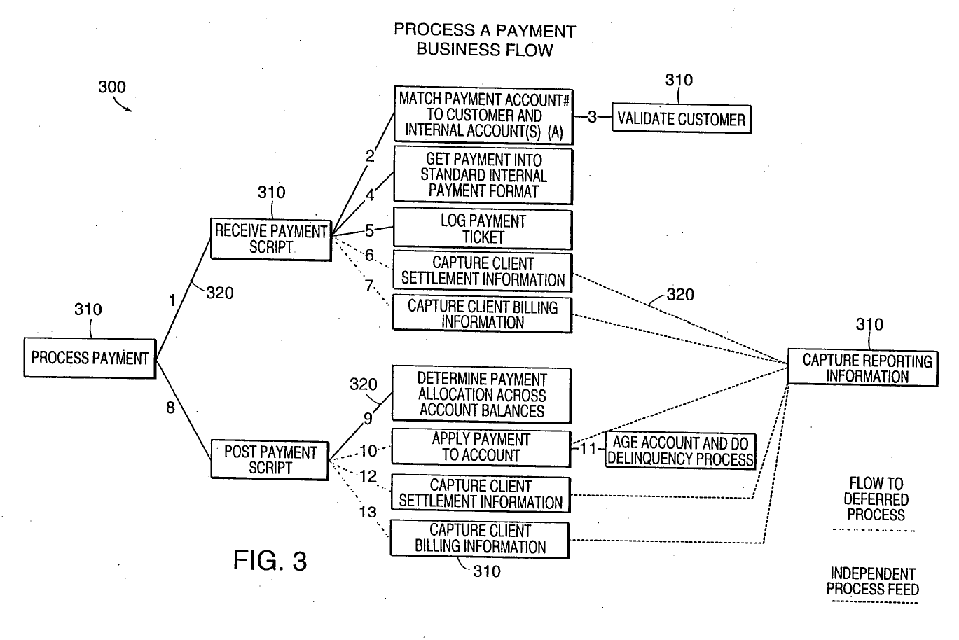

At 110, the business design module 10 provides a graphical layout interface through which a system architect provides a depiction of business processes and the flow of process interactions, as in FIG. 3.

FIG. 3 is a diagram illustrating the graphical layout of a business process design according to one embodiment. In this example, the business process design 300 depicts the business processes and interactions for processing payments within a financial institution. The system architect creates the business process design by adding icons 310 and links 320 to the layout. Each icon 310 identifies a business process, while the links 320 between business process icons 310 represent the flow of processing. According to one embodiment, the graphical layout interface is implemented with a graphical scripting language, such as Universal Markup Language (UML).

Referring back to FIG. 2A at 120, the business design module 10 provides a graphical layout interface through which the system architect defines the business requirements for each business process through the graphical layout interface.

According to one embodiment, the business requirements define business constraints and business drivers. Business drivers, in general, represent the workload that a business process is expected to receive. Typical business drivers include the expected number and kind of business events and the rate at which the events are received.

Business constraints, in general, refer to time and volume constraints imposed by the business needs. For example, business constraints include time constraints and volume constraints. Typical time constraints include business response time, while typical volume constraints include events processed per day or events processed per second, for example. The business constraints provide a standard of comparison for determining whether the proposed system architecture meets the needs of the business organization.

At 130, the architecture construction module 20 provides a graphical user interface through which a system architect maps each business process to a business application. According to one embodiment, the system architect launches a graphical user interface to the architecture construction module by “double-clicking” on a business process icon 310 in the graphical layout of the business process design 300. The system architect is then provided with a list of premodeled business applications. Each listed business application is coupled to a default set of supporting hardware and software component models. The initial model is constructed by simply mapping the available business applications to corresponding business processes defined in the business process design. Thus, the system architect is relieved from defining all of supporting hardware and software components, further simplifying the automated design process.

After mapping all of the business processes, the architecture construction module 20 generates a multi-layer mathematical model of the proposed system architecture. The layers of the model include a business layer, an application layer, and a technology layer. For more information regarding the structure of a multi-layer mathematical model, refer to U.S. patent application Ser. No. 09/127,191 entitled “Method and Apparatus for Designing and Analyzing Information Systems Using Multi-Layer Mathematical Models,” filed Jul. 31, 1998, the entire contents of which are incorporated herein by reference.

At 140, the performance modeling module 30 models performance metrics for each layer of the multi-layer mathematical model generated in the architecture construction module 20. Such metrics include elongation, response time, volume of processed transactions, and transaction processing rates. According to one embodiment, the business drivers defined in the business process design at 120 are included in the modeling of the performance metrics. For more information regarding multi-layer modeling of performance metrics, refer to U.S. patent application Ser. No. 09/127,191 entitled “Method and Apparatus for Designing and Analyzing Information Systems Using Multi-Layer Mathematical Models,” filed Jul. 31, 1998, and to U.S. patent application Ser. No. 09/606,869 entitled “System and Method for Determining Performance Metrics for Constructing Information Systems,” filed Jun. 29, 2000. The entire contents of both applications are incorporated herein by reference. The modeled performance metrics are then forwarded to the comparison module 40.

At 150, the comparison module 40 makes an initial determination as to whether the modeled performance metrics of the business processes satisfy the business requirements as defined in the business process design. According to one embodiment, the comparison is performed as the difference between the value of a modeled performance metric and the value of a corresponding business constraint, such as response time. Fuzzy logic may also be used to ascertain whether a modeled performance metric satisfies a defined business constraint.

If, at 160, the modeled business performance metrics satisfy the business requirements of each business process, the proposed system architecture is forwarded to the output module 60 at 170 to output a detailed description of the specifications of the model based system architecture. The output module 60 formats the system architecture model into a detailed set of “blueprints” describing the construction and implementation of the system architecture. According to one embodiment, the format of the output is a Universal Markup Language (UML) document, which can be displayed readily through an Internet browser. The UML-generated display can display the system architecture containing hyperlinks between components within the business, application, and technology layers.

If, at 160, at least one of the business processes exhibits unacceptable business performance metrics, the comparison module 40 attempts to identify the supporting components models in the application and technology layers causing their unacceptable business performance metrics at 180 in FIG. 2B.

Referring to FIG. 2B at 180, the comparison module 40 evaluates the performance metrics of the supporting hardware and software component models linked to the one or more business processes exhibiting unacceptable business performance metrics. According to one embodiment, the modeled performance metrics of the supporting component models are compared against vendor-provided or modeled benchmarks in order to determine if there are any inefficiencies associated with their operation.

If, at 190, none of the supporting component models exhibits unacceptable modeled performance metrics, then the system architect is notified at 200, through a graphical user interface, that the unacceptable business performance metrics are caused by flaws in the business process design. These flaws may include inefficient business process interactions or unrealistic business requirements. The process returns to 110 providing the system architect with the graphical layout interface of the business design module 10 to modify the business process design.

If, at 190, one or more of the supporting component models do exhibit unacceptable performance metrics, then step 210 forwards the identity of the supporting components and the unacceptable performance metrics to the rule-based modification engine 50 to determine modifications to the system architecture for improvement.

At 210, the modification engine 50 determines modifications to the system architecture to address the unacceptable performance metrics of supporting hardware and software components modeled in the system architecture. According to one embodiment, the rule-based modification engine 50 searches a logic tree implemented within a data store. The identity of the supporting component models and their unacceptable metrics are used to search the logic tree for recommended modifications according to industry standards, vendor benchmarks, or prior modeled results. For example, if an increase in memory size is the recommended modification, the recommended size is a value obtained either from previous modeled results, vendor-provided benchmarks, or industry standard specifications. Such modifications may include replacement of the one or more supporting component models with alternate component models.

If, at 220, the search is successful in finding recommended modifications to the system architecture, then the modifications are proposed to the system architect through a graphical user interface for acceptance at 230.

If, at 240, the system architect rejects all of the proposed modifications, the logic tree is searched again at 210 to locate alternative modifications to the system architecture. If, at 220, the search fails to find additional recommended modifications, then the system architect is notified through a graphical user interface that the unacceptable business performance metrics are caused by flaws in the business process design at 200 and the process returns to 110 providing the system architect with the graphical layout interface of the business design module 10 to modify the business process design.

If, at 240, the architect accepts one or more of the proposed modifications, the model of the system architecture is automatically modified by the architecture construction module 20 with the accepted modifications at 250.

After modifying the system architecture model, the process returns back to 140 for further modeling, repeating the process until the modeled performance metrics of each business process either satisfy the business requirements or the performance metrics of the supporting hardware and software component models cannot be improved further without a change to the business process design.

Once the modeled business performance metrics do satisfy the business requirements, the model of the system architecture is formatted into a detailed description of the system architecture, which may be output from the output module 60 at 170.

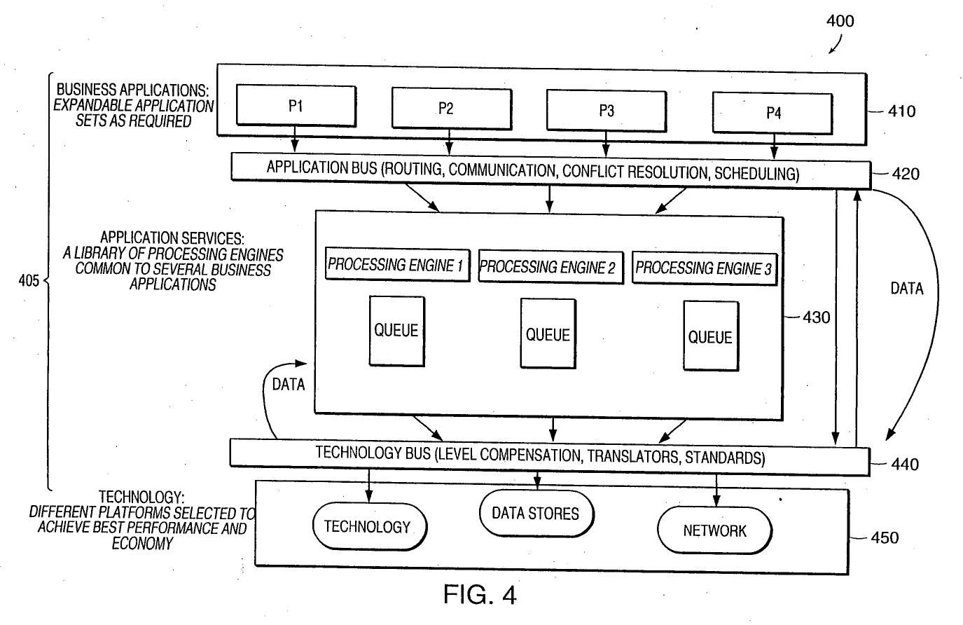

FIG. 4 illustrates a model based architecture of an information system resulting from the automated design process according to the foregoing embodiment of FIGS. 1-2B. Embodiments of the model based architecture 400 include an applications layer 405 and a technology layer 450 with the applications layer 405 further divided into sub-layers, including a business applications layer 410, an application bus layer 420, an application services layer 430, and a technology bus layer 440. The application sub-layers implement a number of guiding principles, constraints, and guidelines in order to design an extendable system architecture that supports complex, multi-dimension, multi-function, and right time critical business solutions.

According to one embodiment, the software component models are separated into either the business applications layer 410 or the application services layer 430. The business applications layer 410 and the application services layer 430 differentiate software components that perform front-end client processing and back-end server processing, respectively. Front-end client processing typically involves real-time and right-time critical processing, while back-end server processing typically involves deferrable, batch processing.

The business applications layer 410 is populated with business application component models that are initially mapped to business processes by the system architect or substituted into the model during the automated design process, as described in FIGS. 2A and 2B. The business applications layer 410 may be further subdivided into a presentation layer and (e.g., graphical user interface) and a business logic layer, allowing for further segmentation.

The application services layer 430 includes a collection of modular service engines, common routines, client-specific and volatile software components that deliver specific services to one or more business applications. An engine includes one or more programs that perform a discrete function. According to one embodiment, components in the application services layer 430 are modeled as queue-based, enabling parallel processing of service requests, substantially reducing processing times. Architecture design styles at this layer may be distributed, pipes-filter, batch sequential, and blackboard, for example.

When a system architect initially maps the business processes to business applications, default application services supporting the selected business application are automatically added to the application services layer 430. The default application services may be replaced during the automated design process, as described in FIGS. 2A and 2B. The application services layer 430 can also be expanded as new application services are required.

An application bus layer 420 facilitates the separation of the business applications and application services layers 410, 430, by providing a number of communication services. All communication between software components in both layers 410, 430 must be requested through the application bus layer 420. The communication services modeled may include code and network communication protocol translation services (e.g., Java to Cobol; TCP/IP to SNA), distribution services (e.g., distributing workload to prevent server overload), event, system, and transaction management services (e.g., providing order and integrity for multiple service requests at each level), security services (e.g., authentication), scripting flow, conflict solving, lock processing, and scheduling and dispatching of service requests. Such communication services are modeled as delays or locks, which affect the overall performance metrics of the information system. According to one embodiment, the application bus layer 420 models a communication middleware, such as messaging and TCP/IP network communication protocols.

Through the separation of software components into the business applications 410 and application services 430 layers, reuse and distribution of software components are facilitated. Reuse and proper distribution reduces the cost of maintenance and development and increases the speed of product delivery. Furthermore, customization may occur in the business applications layer 410 without disrupting services in the application services layer 430

The technology layer 450 provides hardware component models of the physical hardware and operating system upon which the business applications and the application services are deployed. Typical examples of such hardware include data storage devices, processing units and engines, routers, switches, and other network devices. The particular hardware components are determined during the predictive modeling, comparison, and modification stages of the automated design process.

A technology bus layer 440 isolates the technology layer 450 from the application layers 410, 430, avoiding a technology-specific architecture. According to one embodiment, the technology bus layer 440 models an abstract interface (e.g., Java™ virtual machine) for data access or technology services. By incorporating a technology bus layer 440 into the model, the resulting system architecture is not proprietary to a specific set of hardware components. Thus, portability is maximized with the technology bus layer 440, such that physical hardware in the technology layer 450 may be substituted without requiring substantial porting of code to new hardware platforms. In addition, the technology bus layer 440 provides level compensation, network protocol translators, cryptography, and connection management services.

Those of ordinary skill in the art realize that processes involved in an automated system and method for designing model based architectures of information systems may be embodied in an article of manufacture that includes a computer-usable medium. For example, such a computer usable medium can include a readable memory device, such as a hard drive device, a CD-ROM, a DVD-ROM, a computer diskette or solid-state memory components (ROM, RAM), having computer readable program code segments stored thereon. The computer readable medium can also include a communications or transmission medium, such as a bus or a communications link, either optical, wired, or wireless, having program code segments carried thereon as digital or analog data signals.

While this invention has been particularly shown and described with references to preferred embodiments thereof, it will be understood by those skilled in the art that various changes in form and details may be made therein without departing from the scope of the invention encompassed by the appended claims.

Our computation is based on a mathematical network impact algorithm.

Based on a network description that covers all seven layers of the OSI model of U.S. application Ser. No. 09/606,869, the invention algorithm is able to calculate the impact of each application message on the different components of a network. The algorithm takes into account every single protocol used into the network for the message impact repartition. At each level of the OSI model, the algorithm adds resource utilization due to the protocols. At this point we have a realistic view of the load of each network component.

Into passive elements, such as links, specific algorithms are used to determine the response time, throughput and cost.

Into active elements, such as routers, links are made between different network messages on each ingress or egress port and the different router application components or process. The impact of the network load is associated to each process to reflect the real use of the component. To determine the response time, throughput and cost in such complex systems, a predictive mathematical algorithm, based on perturbation theory, gives results with a maximum 1% variation from the physical observation.

The sequence of algorithms described above gives us the possibility to create all kinds of networks. The last realization is an MPLS model in which all the routing protocols that allow dynamic routing, the different Class of Services (CoS), fast convergence . . . have been taken into accounting. This model can accept all types of network implementations in order to represent all types of applications running on MPLS.

The MPLS model is then unique, modular, predictive and accurate.

[image]

[image]

[image]

[image]

[image]

[image]

[image]

[image]

[image]

[image]

[image]

[image]

[image]

[image]

[image]

[image]

[image]

What is claimed is:

1. A process for modeling corporate business system architecture, comprising:
providing a business process design, the business process design describing a plurality of business processes and defining a set of corporate and business requirements for each business process;
constructing a multi-layer mathematical model of a system architecture supporting the business process design, the layers of the multi-layer model comprising a business layer, an application layer, and a technology layer;
modeling performance metrics for each layer of the multi-layer model of the system architecture including cost, quality of service and throughput; and;
from said modeled performance metrics, producing business ephemerides for on-line (real time) and off line corporate analysis.

2. The process of claim 1, further comprising:
comparing the modeled performance metrics with the set of corporate and business requirements for each business process, said comparing producing respective indications of unacceptable performance metrics of one or more corporate and business processes that do not satisfy the set of business requirements defined for them based on the produced indications;
determining modifications to the system architecture.
proposing the modifications to the system architecture;
modeling updated performance metrics for each layer of the model of the system architecture with the proposed modifications;
comparing the updated performance metrics with the set of business requirements for each business process; and
outputting a description of the system architecture if the updated performance metrics satisfy the set of business requirements.

3. The process of claim 1 wherein said modeling performance and/or providing business ephemerides is without exclusivity service oriented architecture.

4. The process of claim 1, wherein constructing the multi-layer mathematical model of the system architecture, comprises:
mapping each business process to an application component model in the applications layer, each application component model linked to one or more component models in the application and technology layers, which support the application component model.

5. The process of claim 4, wherein the application layer further comprises a technology bus, the technology bus modeling an abstract interface for data access or technology services between the components modeled in the application and technology layers.

6. The process of claim 4, wherein the application layer further comprises a application bus, the application bus modeling a communication, distribution, and management interface between application component models in the application layer.

7. The process of claim 4, wherein application component models in the application layer are subdivided into a business applications layer and an application engines layer, the business applications layer comprising models of application components providing real-time or right-time processing, the application engines layer comprising models of application components that provide deferrable processing and support one or more application components in the business applications layer.

8. The process of claim 4, wherein any combination of component models supporting a business process may be substituted to improve unacceptable performance metrics of the business process.

9. A system for modeling corporate system architecture, comprising:
a business process design, the business process design describing a plurality of business processes and defining a set of corporate or business requirements for each business process;
an architecture construction module responsive to the business process design, the architecture construction module constructing a multi-layer mathematical model of a system architecture supporting the business process design, the layers of the multi-Layer model comprising a business layer, an application layer, and a technology layer;
a performance modeling module coupled to the architecture construction module, the performance modeling module modeling performance metrics for each layer of the multi-layer model of the system architecture including cost, quality (class of service) and throughput;
a premodeled ephemerides table;
a comparison module coupled to receive the modeled performance metrics and the business process design, the comparison module comparing the modeled performance metrics with the set of corporate and business requirements for each business process and determining unacceptable performance metrics of one or more business processes that do not satisfy the set of corporate and business requirements defined for them;
a rule-based modification engine, the rule-based engine determining modifications to the system architecture in order to improve the unacceptable performance metrics determined by the comparison module; and
an output module coupled between the rule-based engine and the architecture construction module, the output module proposing the determined modifications to the model of the system architecture.

10. The system of claim 9, wherein:
the performance modeling module further models updated performance metrics for each layer of the model of the system architecture with the proposed modifications;
the comparison module further compares the updated performance metrics with the set of business requirements for each business process; and
the output module further outputs a description of the system architecture if the updated performance metrics satisfy the set of business requirements.

11. The system of claim 9, wherein:
the architecture construction module further identifies supporting component models in the application and technology layers that support the one or more business processes having unacceptable performance metrics;
the comparison module further evaluates the performance metrics of the supporting component models in order to identify one or more supporting component models having unacceptable performance metrics; and
the rule-based engine further searches a data store for modifications to improve the unacceptable performance metrics of the one or more supporting component models.

12. The system of claim 11, wherein the modifications to improve the unacceptable performance metrics of the one or more supporting component models include replacement of the one or more supporting component models with alternate component models.

13. The system of claim 11, wherein:
the output module further proposes that the business process design be modified, if none of the supporting component models in the application or technology layers have unacceptable performance metrics.

14. The system of claim 9, wherein the architecture construction module maps each business process to an application component model in the applications layer, each application component model being linked to one or more component models in the application and technology layers, which support the application component model.

15. A system for modeling a corporate enterprise system architecture, comprising:
means for receiving a business process design, the business process design describing a plurality of business processes and defining a set of corporate and business requirements for each business process;
means for constructing a multi-layer mathematical model of a system architecture supporting the business process design, the layers of the multi-layer model comprising a business layer, an application layer, and a technology layer;
means for modeling performance metrics for each layer of the multi-layer model of the system architecture including cost, quality of service and latency;
means for comparing the modeled performance metrics with the set of business requirements for each business process;
means for determining modifications to the system architecture in order to improve unacceptable performance metrics of one or more business processes that do not satisfy the set of business requirements defined for them; and
means for proposing the modifications to the model of the system architecture.

16. A system architecture that is generated by the process of claim 1.

17. An article of manufacture, comprising:
a computer-usable medium;
a set of computer operating instructions embodied on the medium, including instructions for modeling an enterprise based system architecture, comprising instructions for:
providing a business process design, the business process design describing a plurality of business processes and defining a set of corporate and business requirements for each business process;
constructing a multi-layer mathematical model of a system architecture supporting the business process design, the layers of the multi-layer model comprising a business layer, an application layer, and a technology layer;
modeling performance metrics for each layer of the multi-layer model of the system architecture, including cost, quality of service and latency; and
from said modeled performance metrics, producing business ephemerides for on-line (real time) and off line corporate analysis.
